(19) United States
(12) Patent Application Publication
(10) Pub. No.: US 2023/0111625 A1
(43) Pub. Date: Apr. 13, 2023

(54) GAS SUPPLY SYSTEM

(71) Applicant: HONDA MOTOR CO., LTD., Tokyo (JP)

(72) Inventor: Satoru KAWASE, Tokyo (JP)

(21) Appl. No.: 17/956,411

(22) Filed: Sep. 29, 2022

(30) Foreign Application Priority Data
Oct. 13, 2021 (JP) 2021-167843

(51) Int. Cl. H01M 8/04746; H01M 8/04007; H01M 8/04089; H01M 8/04082

(52) U.S. Cl. CPC H01M 8/04753; H01M 8/04067; H01M 8/04089; H01M 8/04201; H01M 2250/20

(57) ABSTRACT

A valve control unit of a gas supply system acquires a gas pressure of gas supplied to a gas consumption device and a first tank temperature, determines a first pressure threshold value associated with the first tank temperature, closes a first valve to shut off gas from a first tank to the gas consumption device if the gas pressure is less than the first pressure threshold value, and opens the first valve to resume gas supply from the first tank to the gas consumption device after the first valve is closed and if the first tank temperature rises to a first predetermined temperature.

### CROSS-REFERENCE TO RELATED APPLICATIONS

This application is based upon and claims the benefit of priority from Japanese Patent Application No. 2021-167843 filed on Oct. 13, 2021, the contents of which are incorporated herein by reference.

### BACKGROUND OF THE INVENTION

### Field of the Invention

The present invention relates to a gas supply system that switches between supply and shutoff of gas from a plurality of tanks to a gas consumption device.

### Description of the Related Art

A fuel cell system includes a tank and a fuel cell. The tank stores hydrogen gas. The fuel cell generates electricity by reaction between hydrogen and oxygen. WO 2005/010427 A1 discloses a gas supply system provided in such a fuel cell system. In this gas supply system, the controller selects one of a plurality of tanks and supplies hydrogen gas from the selected tank to the fuel cell.

### SUMMARY OF THE INVENTION

The gas supply system of WO 2005/010427 A1 does not supply hydrogen gas from multiple tanks to the fuel cell simultaneously. In the case of a gas supply system that simultaneously supplies hydrogen gas from a plurality of tanks to the fuel cell, a controller performs, for example, the following control.

The controller detects the pressure of the hydrogen gas supplied to the fuel cell and determines the detected pressure as the internal pressure of each tank. When the internal pressure of a tank decreases to a pressure threshold value or less, the hydrogen gas cannot be supplied from the tank to the fuel cell. Therefore, the controller determines that there is a gas shortage when the pressure of the hydrogen gas decreases to a predetermined value or less. The controller stops supply of hydrogen gas to the fuel cell when it is determined that there is a gas shortage.

In such a case, a sufficient amount of hydrogen gas may remain in some tanks. In addition, a certain amount of hydrogen gas also still remains in the tank whose internal pressure has decreased. Therefore, in a gas supply system that simultaneously supplies hydrogen gas from a plurality of tanks to the fuel cell, hydrogen gas cannot be effectively used.

An object of the present invention is to solve the above problem.

According to an aspect of the present invention, there is provided a gas supply system including: a first tank and a second tank configured to store gas; a gas consumption device configured to consume the gas; a first valve configured to switch between supply and shutoff of the gas from the first tank to the gas consumption device; a second valve configured to switch between supply and shutoff of the gas from the second tank to the gas consumption device; and a valve control unit configured to perform opening/closing control of the first valve and opening/closing control of the second valve, wherein the gas supply system further includes a storage device configured to store a first pressure threshold value that is a threshold value of a gas pressure for determining whether or not to supply the gas from the first tank to the gas consumption device, the first pressure threshold value is stored in association with a first tank temperature that is an internal temperature of the first tank, and the valve control unit is configured to: open the first valve to supply the gas from the first tank to the gas consumption device, and open the second valve to supply the gas from the second tank to the gas consumption device; acquire the gas pressure of the gas supplied to the gas consumption device and the first tank temperature; determine the first pressure threshold value associated with the first tank temperature; close the first valve to shut off the gas from the first tank to the gas consumption device if the gas pressure is less than the first pressure threshold value; and open the first valve to resume supply of the gas from the first tank to the gas consumption device after the first valve is closed and if the first tank temperature rises to a first predetermined temperature.

According to the present invention, hydrogen gas can be effectively used.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a view schematically showing an internal structure of a fuel cell vehicle;

FIG. 2 is a diagram showing a configuration of a gas supply system;

FIG. 3 is a diagram showing a pressure threshold value corresponding to a tank temperature;

FIG. 4 is a flowchart of a main process relating to a first tank;

FIG. 5 is a flowchart of a gas supply process relating to the first tank; and

FIG. 6 is a flow chart of a gas shutoff process relating to the first tank.

### DESCRIPTION OF THE INVENTION

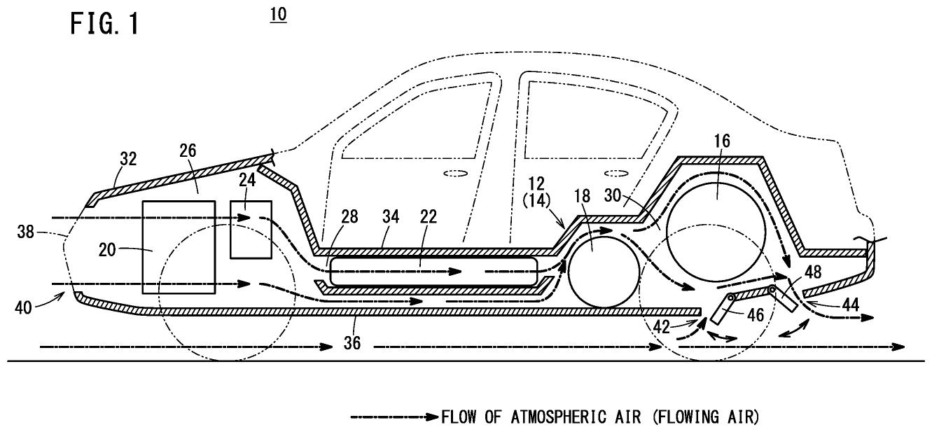

FIG. 1 is a view schematically showing an internal structure of a fuel cell vehicle 10. A gas supply system 14 according to the present invention can be used in a system for supplying gas from a plurality of tanks to a gas consumption device. In the present specification, a gas supply system 14 for use in a fuel cell system 12 of the fuel cell vehicle 10 is described. The gas supply system 14 according to the present invention may supply gas to a device other than a fuel cell stack 20.

### [Vehicle 10]

Hereinafter, the fuel cell vehicle 10 will be simply referred to as a vehicle 10. The vehicle 10 includes a fuel cell system 12. The fuel cell system 12 includes the gas supply system 14 according to the present invention. The fuel cell system 12 includes, for example, a plurality of tanks (a first tank 16 and a second tank 18), a fuel cell stack 20, a battery 22, and a motor 24.

Both the first tank 16 and the second tank 18 store hydrogen gas. In the present embodiment, the capacity of the first tank 16 is larger than the capacity of the second tank 18. The fuel cell stack 20 is a gas consumption device that consumes hydrogen gas. Hydrogen gas is supplied from each tank to the fuel cell stack 20, and oxygen in the atmosphere is supplied thereto. The fuel cell stack 20 generates electricity by a chemical reaction between hydrogen and oxygen. The battery 22 can be charged and discharged. The motor 24 is driven by electric power supplied from the fuel cell stack 20 or the battery 22. The motor 24 is a traction motor.

A motor compartment 26 is located in a front portion of the vehicle 10. A battery compartment 28 is located in an intermediate portion of the vehicle 10. A tank compartment 30 is located in a rear portion of the vehicle 10. The motor compartment 26 is defined by an engine hood (bonnet) 32, a front portion of a floor panel 34, and a front portion of an undercover 36. The front portion of the floor panel 34 is also referred to as a dash panel. A front grille 38 is provided at a front end portion of the motor compartment 26. A plurality of first introduction ports 40 are formed in the front grille 38.

The battery compartment 28 is formed by an intermediate portion of the floor panel 34 and an intermediate portion of the undercover 36. The tank compartment 30 is formed by a rear portion of the floor panel 34 and a rear portion of the undercover 36. A second introduction port 42 and a discharge port 44 are formed in a rear portion of the undercover 36. The second introduction port 42 is located in front of the discharge port 44. The second introduction port 42 is provided with an openable and closable door 46. The discharge port 44 is provided with an openable and closable door 48.

The fuel cell stack 20 and the motor 24 are housed in the motor compartment 26. The battery 22 is housed in the battery compartment 28. The first tank 16 and the second tank 18 are housed in the tank compartment 30. The first tank 16 is located rearward of the second tank 18. The first tank 16 is located in front of the discharge port 44. The second tank 18 is located in front of the second introduction port 42.

The motor compartment 26 and the battery compartment 28 communicate with each other. The battery compartment 28 and the tank compartment 30 communicate with each other. When the vehicle 10 moves forward, atmospheric air flows into the motor compartment 26 through the first introduction port 40. The atmospheric air flowing into the motor compartment 26 flows into the battery compartment 28. The air absorbs heat from heat generation sources such as the motor 24 and the battery 22. Atmospheric air flows into the motor compartment 26 with the doors 46 and 48 being open. The atmospheric air releases heat to the first tank 16 and the second tank 18. The air that has flowed into the motor compartment 26 is discharged from the discharge port 44 to the outside of the vehicle 10. On the other hand, when the doors 46 and 48 are closed, the tank compartment 30 is closed. Therefore, the atmospheric air does not flow into the motor compartment 26.

### [Configuration of Gas Supply System 14]

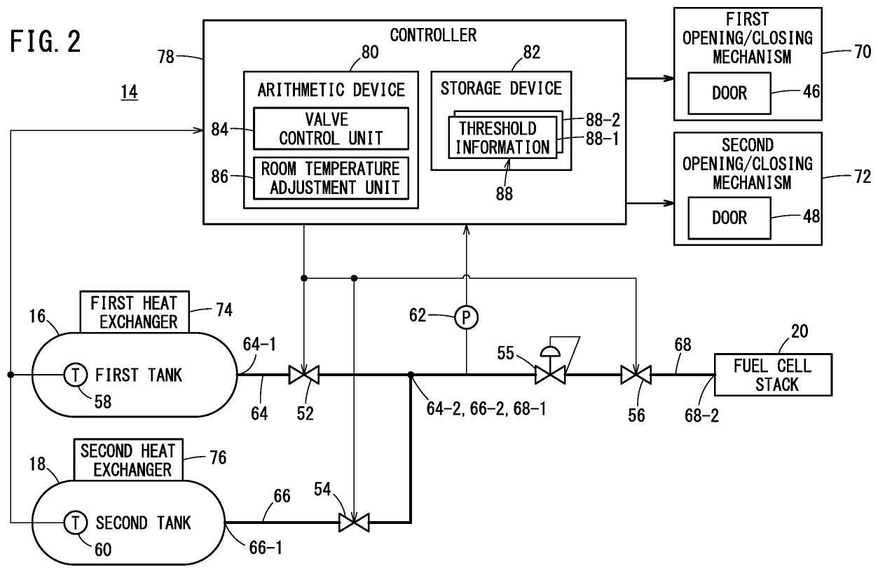

FIG. 2 is a diagram showing a configuration of the gas supply system 14. As described above, the gas supply system 14 is included in the fuel cell system 12. The gas supply system 14 includes a plurality of tanks (a first tank 16 and a second tank 18), a fuel cell stack 20, a plurality of valves (a first valve 52, a second valve 54, a pressure reducing valve 55, and an injector 56), a plurality of temperature sensors (a first temperature sensor 58 and a second temperature sensor 60), and a pressure sensor 62. The gas supply system 14 according to the present embodiment includes two tanks. However, the gas supply system 14 may include three or more tanks.

The first tank 16 and the fuel cell stack 20 are connected to each other by a first pipe 64 and a common pipe 68. The second tank 18 and the fuel cell stack 20 are connected by a second pipe 66 and the common pipe 68. An upstream end 64-1 of the first pipe 64 is connected to a gas outlet port of the first tank 16. An upstream end 66-1 of the second pipe 66 is connected to a gas outlet port of the second tank 18. Each of a downstream end 64-2 of the first pipe 64 and a downstream end 66-2 of the second pipe 66 is connected to an upstream end 68-1 of the common pipe 68. A downstream end 68-2 of the common pipe 68 is connected to a gas inlet of the fuel cell stack 20.

A first valve 52 is provided in the first pipe 64. The first valve 52 opens and closes in response to a signal output from a controller 78. When the first valve 52 is opened, hydrogen gas released from the first tank 16 flows through the first pipe 64 and the common pipe 68 and is supplied to the fuel cell stack 20. When the first valve 52 is closed, hydrogen gas from the first tank 16 to the fuel cell stack 20 is shut off.

A second valve 54 is provided in the second pipe 66. The second valve 54 opens and closes in response to a signal output from the controller 78. When the second valve 54 is opened, hydrogen gas released from the second tank 18 flows through the second pipe 66 and the common pipe 68 and is supplied to the fuel cell stack 20. When the second valve 54 is closed, hydrogen gas from the second tank 18 to the fuel cell stack 20 is shut off.

The common pipe 68 is provided with the pressure reducing valve 55 and the injector 56. The pressure reducing valve 55 is disposed upstream of the injector 56. The pressure reducing valve 55 reduces the pressure of hydrogen gas supplied from the upstream side and discharges the hydrogen gas to the downstream side. The injector 56 adjusts the amount of hydrogen gas supplied to the fuel cell stack 20 in accordance with a signal output from the controller 78.

The first temperature sensor 58 is attached to the first tank 16. The first temperature sensor 58 detects the internal temperature of the first tank 16. The internal temperature of the first tank 16 is referred to as a first tank temperature. Instead of detecting the internal temperature of the first tank 16, the first temperature sensor 58 may detect the temperature of the hydrogen gas released from the first tank 16. For example, the first temperature sensor 58 may detect the temperature of the hydrogen gas flowing through the first pipe 64. The first temperature sensor 58 outputs a detection value to the controller 78.

The second temperature sensor 60 is attached to the second tank 18. The second temperature sensor 60 detects the internal temperature of the second tank 18. The internal temperature of the second tank 18 is referred to as a second tank temperature. Instead of detecting the internal temperature of the second tank 18, the second temperature sensor 60 may detect the temperature of the hydrogen gas released from the second tank 18. For example, the second temperature sensor 60 may detect the temperature of the hydrogen gas flowing through the second pipe 66. The second temperature sensor 60 outputs a detection value to the controller 78.

The common pipe 68 is provided with the pressure sensor 62. The pressure sensor 62 detects the gas pressure of the hydrogen gas between the upstream end 68-1 of the common pipe 68 and the pressure reducing valve 55. The pressure sensor 62 outputs a detection value to the controller 78.

The gas supply system 14 includes a first opening/closing mechanism 70 and a second opening/closing mechanism 72. The first opening/closing mechanism 70 has an actuator that opens and closes the door 46 of the second introduction port 42. The second opening/closing mechanism 72 includes an actuator that opens and closes the door 48 of the discharge port 44. Each actuator is operated by electric power supplied from the controller 78.

The gas supply system 14 includes a plurality of heat exchangers (a first heat exchanger 74 and a second heat exchanger 76). The first heat exchanger 74 is attached to an outer peripheral surface of the first tank 16. The second heat exchanger 76 is attached to an outer peripheral surface of the second tank 18. For example, the first heat exchanger 74 includes a circulation path through which heat exchange medium flows, and a pump. The first portion of the circulation path is disposed along the outer peripheral surface of the first tank 16. The second portion of the circulation path is disposed along the outer peripheral surface of the heat source (motor 24, battery 22). The second portion of the circulation path may be exposed to the atmosphere. The configuration of the second heat exchanger 76 is the same as the configuration of the first heat exchanger 74. The first heat exchanger 74 warms the first tank 16 while the vehicle 10 is traveling. The second heat exchanger 76 warms the second tank 18 while the vehicle 10 is traveling.

The gas supply system 14 includes a controller 78. The controller 78 includes an arithmetic device 80 and a storage device 82.

The arithmetic device 80 includes a processing circuit. The processing circuit may be a processor such as a CPU. The processing circuit may be an integrated circuit such as an ASIC or an FPGA. The processor can execute various processes by executing a program stored in the storage device 82. The arithmetic device 80 functions as a valve control unit 84 and a room temperature adjustment unit 86. At least a part of the processes of the valve control unit 84 and the processes of the room temperature adjustment unit 86 may be executed by an electronic circuit including a discrete device.

The valve control unit 84 controls opening and closing of the first valve 52, opening and closing of the second valve 54, and operation of the injector 56. The room temperature adjustment unit 86 controls operation of the actuator of the first opening/closing mechanism 70 and operation of the actuator of the second opening/closing mechanism 72.

The storage device 82 includes a volatile memory and a nonvolatile memory. As examples of the volatile memory, there may be cited a RAM or the like. The volatile memory is used as a working memory of the processor. The volatile memory temporarily stores data and the like necessary for processing or computing. As examples of the nonvolatile memory, there may be cited a ROM, a flash memory, or the like. The nonvolatile memory is used as storage memory. The nonvolatile memory stores programs, tables, maps, and the like. At least a portion of the storage device 82 may be included in the processor, integrated circuit, or the like as described above.

The nonvolatile memory stores threshold information 88. The threshold information 88 is created for each tank. That is, the nonvolatile memory stores threshold information 88-1 of the first tank 16 and threshold information 88-2 of the second tank 18. The threshold information 88 is used to determine whether or not to supply hydrogen gas to the fuel cell stack 20 from a tank that is a determination target. In other words, the threshold information 88 is used to determine whether or not the determination target tank is usable.

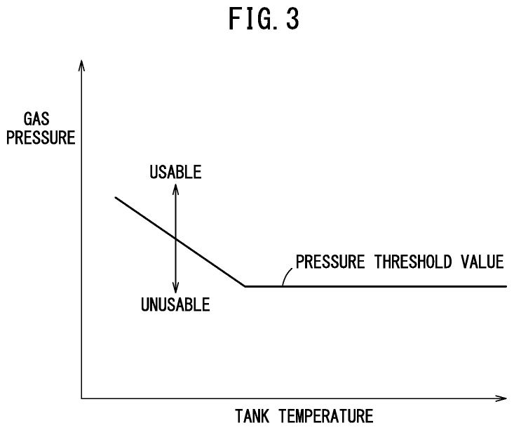

As shown in FIG. 3, the threshold information 88 includes information regarding a threshold value of the gas pressure. The threshold value of the gas pressure is referred to as a pressure threshold value. The pressure threshold value of the first tank 16 is referred to as a first pressure threshold value. The pressure threshold value of the second tank 18 is referred to as a second pressure threshold value. The pressure threshold value is determined for each tank temperature. The pressure threshold value is determined according to the shape and capacity of the tank, the material for the tank, and the like. For example, a minimum gas pressure required for supplying hydrogen gas from the tank to the fuel cell stack 20 is set as the pressure threshold value.

### [Processes Performed by Controller 78]

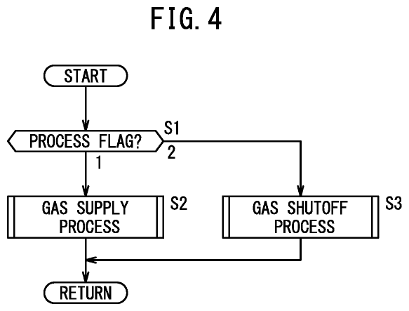

Processes (main process, gas supply process, and gas shutoff process) performed by the controller 78 will be described with reference to FIGS. 4 to 6. The processes shown in FIGS. 4 to 6 relate to control of hydrogen gas released from the first tank 16.

### [Main Process]

FIG. 4 is a flowchart of a main process relating to the first tank 16. The controller 78 executes the main process at a constant cycle during a period from when the electric system of the vehicle 10 is started until when the electric system is stopped. The room temperature adjustment unit 86 closes the door 46 and the door 48 when the electric system of the vehicle 10 is started. The valve control unit 84 places the first valve 52 and the second valve 54 into the open state at the time of starting the electric system of the vehicle 10. Further, the valve control unit 84 sets the process flag to 1 at the time of starting the electric system of the vehicle 10. The process flag is a flag for determining which process (gas supply process or gas shutoff process) should be executed in each cycle.

In step S1, the valve control unit 84 determines whether the process flag is 1 or 2. When the process flag is 1 (step S1: 1), the control proceeds to step S2. On the other hand, when the process flag is 2 (step S1: 2), the control proceeds to step S3.

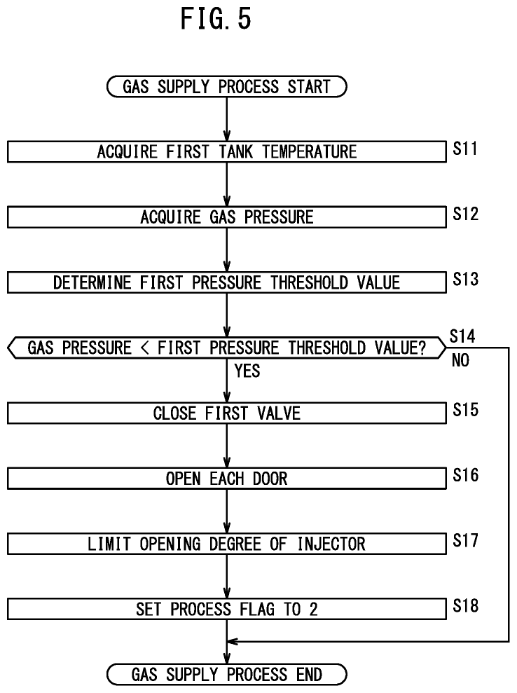

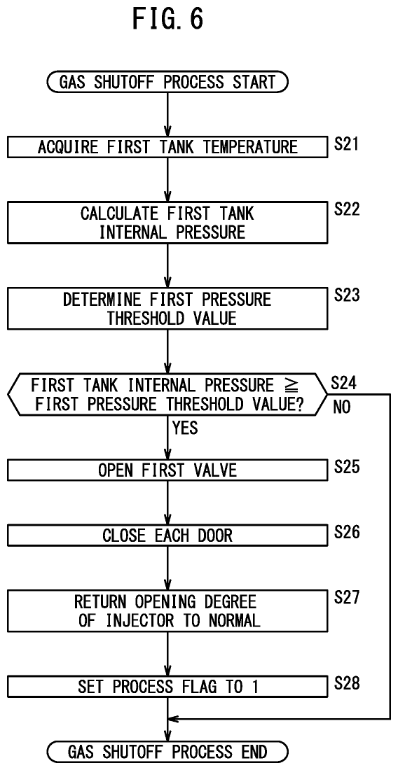

When the control proceeds from step S1 to step S2, the gas supply process shown in FIG. 5 is performed. On the other hand, when the control proceeds from step S1 to step S3, the gas shutoff process shown in FIG. 6 is performed.

### [Gas Supply Process]

FIG. 5 is a flowchart of a gas supply process relating to the first tank 16. In step S2 shown in FIG. 4, the following series of steps of the gas supply process are performed. The gas supply process is performed in a state in which hydrogen gas is supplied from the first tank 16 to the fuel cell stack 20.

In step S11, the valve control unit 84 acquires the first tank temperature from the first temperature sensor 58. Upon completion of step S11, the process proceeds to step S12.

In step S12, the valve control unit 84 acquires the gas pressure from the pressure sensor 62. Upon completion of step S12, the process proceeds to step S13.

In step S13, the valve control unit 84 uses the threshold information 88-1 for the first tank 16 to determine the first pressure threshold value corresponding to (associated with) the first tank temperature acquired in step S11. Upon completion of step S13, the process proceeds to step S14.

In step S14, the valve control unit 84 compares the gas pressure acquired in step S12 with the first pressure threshold value determined in step S13. When the gas pressure is less than the first pressure threshold value (step S14: YES), the process proceeds to step S15. On the other hand, when the gas pressure is equal to or higher than the first pressure threshold value (step S14: NO), the gas supply process is ended. In this case, hydrogen gas continues to be supplied from the first tank 16 to the fuel cell stack 20.

When the process proceeds from step S14 to step S15, the valve control unit 84 outputs a closing signal to the first valve 52. The first valve 52 is switched from the open state to the closed state in response to the closing signal. Then, hydrogen gas from the first tank 16 to the fuel cell system 12 is shut off. Even when the first tank 16 is in the closed state, if the second tank 18 is in the open state, hydrogen gas continues to be supplied from the second tank 18 to the fuel cell system 12. Upon completion of step S15, the process proceeds to step S16.

In step S16, the room temperature adjustment unit 86 supplies opening power to each of the actuator of the first opening/closing mechanism 70 and the actuator of the second opening/closing mechanism 72. The actuator of the first opening/closing mechanism 70 opens the door 46 by the supply of the opening power. The actuator of the second opening/closing mechanism 72 opens the door 48 by the supply of the opening power. Then, the tank compartment 30 is opened.

Atmospheric air flowing into the vehicle 10 from the first introduction port 40 flows into the tank compartment 30 after flowing through the motor compartment 26 and the battery compartment 28. Further, atmospheric air flows into the tank compartment 30 from the door 46. The air that has flowed into the tank compartment 30 passes through the discharge port 44 and is discharged to the outside of the tank compartment 30. The temperature of atmospheric air is higher than the temperature of the first tank 16. Therefore, the first tank 16 is warmed. Upon completion of step S16, the process proceeds to step S17.

In step S17, the valve control unit 84 outputs a restriction signal to the injector 56. The injector 56 restricts the supply amount of the hydrogen gas according to the restriction signal. For example, the injector 56 makes the supply amount of the hydrogen gas to the fuel cell stack 20 smaller than the supply amount of the hydrogen gas at normal time. As a result, the amount of hydrogen gas consumed by the fuel cell stack 20 is reduced. This makes it possible to reduce the rate of decrease in hydrogen gas amount in the second tank 18 having a small capacity. Then, the usable time of the second tank 18 is prolonged. Further, it is possible to gain time for recovering the temperature of the first tank 16.

In step S18, the valve control unit 84 changes the process flag from 1 to 2. When step S18 is completed, the gas supply process is completed.

### [Gas Shutoff Process]

FIG. 6 is a flowchart of a gas shutoff process relating to the first tank 16. In step S3 shown in FIG. 4, the following series of steps of the gas shutoff process is performed. The gas shutoff process is performed in a state where hydrogen gas from the first tank 16 to the fuel cell stack 20 is shut off.

In step S21, the valve control unit 84 acquires the first tank temperature from the first temperature sensor 58. When step S21 is completed, the process transitions to step S22.

In step S22, the valve control unit 84 calculates the internal pressure of the first tank 16 using the first tank temperature acquired in step S21 and the information of the storage device 82. The internal pressure of the first tank 16 is referred to as a first tank internal pressure. There is a correlation between the tank temperature and the tank internal pressure. The storage device 82 stores information on the correlation between the tank temperature and the tank internal pressure for each tank. When step S22 is completed, the process transitions to step S23.

In step S23, the valve control unit 84 uses the threshold information 88-1 for the first tank 16 to determine the first pressure threshold value corresponding to (associated with) the first tank temperature acquired in step S22. When step S23 is completed, the process transitions to step S24.

In step S24, the valve control unit 84 compares the first tank internal pressure calculated in step S22 with the first pressure threshold value determined in step S23. When the first tank internal pressure is equal to or higher than the first pressure threshold value (step S24: YES), the process proceeds to step S25. On the other hand, when the first tank internal pressure is less than the first pressure threshold value (step S24: NO), the gas shutoff process is ended. In this case, the shutoff of hydrogen gas from the first tank 16 to the fuel cell stack 20 is continued.

When the process proceeds from step S24 to step S25, the valve control unit 84 outputs an opening signal to the first valve 52. The first valve 52 is switched from the closed state to the open state in response to the open signal. Then, hydrogen gas is supplied from the first tank 16 to the fuel cell system 12. Upon completion of step S25, the process proceeds to step S26.

In step S26, the room temperature adjustment unit 86 supplies closing electric power to each of the actuator of the first opening/closing mechanism 70 and the actuator of the second opening/closing mechanism 72. The actuator of the first opening/closing mechanism 70 closes the door 46 by the supply of the closing power. The actuator of the second opening/closing mechanism 72 closes the door 48 by the supply of the closing power. Then, the tank compartment 30 is closed. Upon completion of step S26, the process proceeds to step S27.

In step S27, the valve control unit 84 outputs a normal signal to the injector 56. In response to the normal signal, the injector 56 returns the amount of hydrogen gas supplied to the fuel cell stack 20 to the state before the restriction. Upon completion of step S27, the process proceeds to step S28.

In step S28, the valve control unit 84 changes the process flag from 2 to 1. When step S28 is completed, the gas shutoff process is completed.

### [Process for Second Tank 18]

The controller 78 performs the same processes as the processes shown in FIGS. 4 to 6 also regarding the control of hydrogen gas released from the second tank 18. In this case, in the description of each process, “the first tank 16” is replaced with “the second tank 18”. In the description of each process, the “first valve 52” is replaced with the “second valve 54”. In the description of the gas supply process, the “first pressure threshold value” is replaced with a “second pressure threshold value”.

In the case of the gas supply system 14 having three or more tanks, the controller 78 performs the same processes as the processes shown in FIGS. 4 to 6 for each tank.

### [Modifications]

The valve control unit 84 may determine whether to open or close the first valve 52 by calculating the remaining amount of hydrogen gas in the first tank 16 and comparing the calculated remaining amount of hydrogen gas with a remaining amount threshold value. For example, the valve control unit 84 can calculate the weight (remaining amount) of the hydrogen gas remaining in the first tank 16 from the first tank temperature, the gas pressure, and the capacity of the first tank 16.

In the embodiment described above, the arithmetic device 80 performs the processes shown in FIGS. 4 to 6 for each of the first tank 16 and the second tank 18. The arithmetic device 80 may perform the processes shown in FIGS. 4 to 6 on only one of the first tank 16 and the second tank 18. For example, the arithmetic device 80 may perform the processes shown in FIGS. 4 to 6 on only the first tank 16. Since the first tank 16 is larger than the second tank 18, the tank temperature and the internal pressure of the first tank are likely to decrease. Therefore, it is effective to perform the processes shown in FIGS. 4 to 6 on the first tank 16.

### Invention Obtained from Embodiment

The invention that can be grasped from the above embodiment will be described below.

According to an aspect of the present invention, the gas supply system (14) includes: the first tank (16) and the second tank (18) configured to store gas; the gas consumption device (20) configured to consume the gas; the first valve (52) configured to switch between supply and shutoff of the gas from the first tank to the gas consumption device; the second valve (54) configured to switch between supply and shutoff of the gas from the second tank to the gas consumption device; and the valve control unit (84) configured to perform opening/closing control of the first valve and opening/closing control of the second valve, the gas supply system further includes the storage device (82) configured to store a first pressure threshold value that is a threshold value of a gas pressure for determining whether or not to supply the gas from the first tank to the gas consumption device, the first pressure threshold value is stored in association with a first tank temperature that is an internal temperature of the first tank, and the valve control unit is configured to: open the first valve to supply the gas from the first tank to the gas consumption device, and open the second valve to supply the gas from the second tank to the gas consumption device; acquire the gas pressure of the gas supplied to the gas consumption device and the first tank temperature; determine the first pressure threshold value associated with the first tank temperature; close the first valve to shut off the gas from the first tank to the gas consumption device if the gas pressure is less than the first pressure threshold value; and open the first valve to resume supply of the gas from the first tank to the gas consumption device after the first valve is closed and if the first tank temperature rises to a first predetermined temperature.

In the above configuration, when the internal pressure of the first tank decreases, the valve control unit shuts off hydrogen gas supplied from the first tank to the gas consumption device, and continues the supply of hydrogen gas from the second tank to the gas consumption device. Therefore, according to the above configuration, it is possible to effectively use the hydrogen gas in the second tank. Further, in the above configuration, the valve control unit increases the temperature of the first tank. When the temperature of the first tank rises, the internal pressure of the first tank also rises accordingly. When the internal pressure of the first tank increases, hydrogen gas can be supplied from the first tank to the gas consumption device. Therefore, according to the above configuration, it is possible to effectively use the hydrogen gas in the first tank. When the gas supply system is mounted on a fuel cell vehicle, the cruising range of the fuel cell vehicle can be extended.

According to an aspect of the present invention, the storage device may store a second pressure threshold value that is a threshold value of the gas pressure for determining whether or not to supply the gas from the second tank to the gas consumption device, the second pressure threshold value may be stored in association with a second tank temperature that is an internal temperature of the second tank, and the valve control unit may be configured to: acquire the gas pressure of the gas supplied to the gas consumption device and the second tank temperature; determine the second pressure threshold value associated with the second tank temperature; close the second valve to shut off the gas from the second tank to the gas consumption device if the gas pressure is less than the second pressure threshold value; and open the second valve to resume supply of the gas from the second tank to the gas consumption device after the second valve is closed and if the second tank temperature rises to a second predetermined temperature.

In an aspect of the present invention, the gas supply system may further include the adjustment valve (56) configured to adjust an amount of gas supplied to the gas consumption device, and if the first valve is closed, the valve control unit may control the adjustment valve to restrict an amount of gas supplied from the second tank to the gas consumption device.

When the first valve is closed, the gas consumption device uses the gas released from the second tank. In such a case, there is a risk that gas shortage will occur in the second tank. In the above configuration, releasing of gas from the second tank is restricted. Therefore, with the above configuration, it is possible to reduce the risk that gas shortage will occur in the second tank.

An aspect of the present invention may further include the room temperature adjustment unit (86) configured to warm the inside of the tank compartment (30) accommodating the first tank, after the first valve is closed.

According to the above configuration, the first tank temperature can be quickly recovered, and the internal pressure of the first tank can be quickly increased.

In an aspect of the present invention, the tank compartment may include the discharge port (44) through which gas inside the tank compartment is discharged to outside of the tank compartment, and the room temperature adjustment unit discharges gas flowing into the tank compartment to the outside of the tank compartment by placing the discharge port into an open state.

In an aspect of the present invention, the gas supply system may further include the heat exchanger (74) attached to the first tank, and the heat exchanger may absorb heat from a portion other than the first tank and release heat to the first tank.

According to the above configuration, the first tank temperature can be quickly recovered, and the internal pressure of the first tank can be quickly increased.

The present invention is not limited to the above disclosure, and various modifications are possible without departing from the essence and gist of the present invention.

What is claimed is:

1. A gas supply system comprising:
a first tank and a second tank configured to store gas;
a gas consumption device configured to consume the gas;
a first valve configured to switch between supply and shutoff of the gas from the first tank to the gas consumption device;
a second valve configured to switch between supply and shutoff of the gas from the second tank to the gas consumption device;
a storage device that stores computer-executable instructions; and
one or more processors that execute the computer-executable instructions, wherein the one or more processors execute the computer-executable instructions to cause the gas supply system to perform opening/closing control of the first valve and opening/closing control of the second valve,
wherein
the storage device further stores a first pressure threshold value that is a threshold value of a gas pressure for determining whether or not to supply the gas from the first tank to the gas consumption device,
the first pressure threshold value is stored in association with a first tank temperature that is an internal temperature of the first tank, and
the one or more processors cause the gas supply system to:
open the first valve to supply the gas from the first tank to the gas consumption device, and open the second valve to supply the gas from the second tank to the gas consumption device;
acquire a gas pressure of the gas supplied to the gas consumption device and the first tank temperature;
determine the first pressure threshold value associated with the first tank temperature;
close the first valve to shut off the gas from the first tank to the gas consumption device if the gas pressure is less than the first pressure threshold value; and
open the first valve to resume supply of the gas from the first tank to the gas consumption device after the first valve is closed and if the first tank temperature rises to a first predetermined temperature.

2. The gas supply system according to claim 1, wherein
the storage device further stores a second pressure threshold value that is a threshold value of the gas pressure for determining whether or not to supply the gas from the second tank to the gas consumption device,
the second pressure threshold value is stored in association with a second tank temperature that is an internal temperature of the second tank, and
the one or more processors cause the gas supply system to:
acquire the gas pressure of the gas supplied to the gas consumption device and the second tank temperature;
determine the second pressure threshold value associated with the second tank temperature;
close the second valve to shut off the gas from the second tank to the gas consumption device if the gas pressure is less than the second pressure threshold value; and
open the second valve to resume supply of the gas from the second tank to the gas consumption device after the second valve is closed and if the second tank temperature rises to a second predetermined temperature.

3. The gas supply system according to claim 1, further comprising an adjustment valve configured to adjust an amount of the gas supplied to the gas consumption device,
wherein if the first valve is closed, the one or more processors cause the gas supply system to control the adjustment valve to restrict an amount of the gas supplied from the second tank to the gas consumption device.

4. The gas supply system according to claim 1, wherein
the one or more processors cause the gas supply system to warm an inside of a tank compartment accommodating the first tank, after the first valve is closed.

5. The gas supply system according to claim 4, wherein
the tank compartment includes a discharge port through which gas inside the tank compartment is discharged to outside of the tank compartment, and
the one or more processors cause the gas supply system to place the discharge port into an open state and thereby discharge gas flowing into the tank compartment, to the outside of the tank compartment.

6. The gas supply system according to claim 1, further comprising a heat exchanger attached to the first tank,
wherein the heat exchanger absorbs heat from a portion other than the first tank and releases heat to the first tank.
